(19) United States
(12) Patent Application Publication
(10) Pub. No.: US 2007/0216416 A1
(43) Pub. Date: Sep. 20, 2007

(54) Electromagnetic and Magnetostatic Shield To Perform Measurements Ahead of the Drill Bit

(75) Inventor: Gregory B. Itskovich, Houston, TX (US)

Correspondence Address: MADAN, MOSSMAN & SRIRAM, P.C., 2603 AUGUSTA, SUITE 700, HOUSTON, TX, 77057, US

(73) Assignee: BAKER HUGHES INCORPORATED, Houston, TX (US)

(21) Appl. No.: 11/682,381

(22) Filed: Mar. 6, 2007

Related U.S. Application Data
(60) Provisional application No. 60/782,447, filed on Mar. 15, 2006.

(51) Int. Cl. G01V 3/18

(52) U.S. Cl. 324/339

(57) ABSTRACT

A transmitter on a bottomhole assembly (BHA) is used for generating a transient electromagnetic signal in an earth formation. A receiver on the BHA receives signals that are indicative of formation resistivity and distances to bed boundaries. A combination of electromagnetic shielding and magnetostatic shielding enables determination of distance to an interface ahead of the drillbit.

### CROSS-REFERENCES TO RELATED APPLICATIONS

This application claims priority from U.S. provisional patent application Ser. No. 60/782,447 filed on Mar. 15, 2006.

### BACKGROUND OF THE INVENTION

1. Field of the Invention

The invention relates to the field of electromagnetic induction well logging. More specifically, the present invention is a method of reducing effects of conductive drill pipes on signals in transient electromagnetic measurements for evaluation of earth formations ahead of the drillbit.

2. Description of the Related Art

Electromagnetic induction resistivity instruments can be used to determine the electrical conductivity of earth formations surrounding a wellbore. An electromagnetic induction well logging instrument is described, for example, in U.S. Pat. No. 5,452,761 issued to Beard et al. The instrument described in the Beard '761 patent includes a transmitter coil and a plurality of receiver coils positioned at axially spaced apart locations along the instrument housing. An alternating current is passed through the transmitter coil. Voltages that are induced in the receiver coils as a result of alternating magnetic fields induced in the earth formations are then measured. The magnitude of certain phase components of the induced receiver voltages are related to the conductivity of the media surrounding the instrument.

Deep-looking electromagnetic tools are used to achieve a variety of different objectives. Deep-looking tools attempt to measure the reservoir properties between wells at distances ranging from tens to hundreds of meters (ultra-deep scale). There are single-well and cross-well approaches, most of which are rooted in the technologies of radar/seismic wave propagation physics. This group of tools is naturally limited by, among other things, their applicability to only high-resistivity formations and the power available downhole.

At the ultra-deep scale, technology may be employed based on transient field behavior. The transient electromagnetic field method has been used in surface geophysics. Typically, voltage or current pulses that are excited in a transmitter initiate the propagation of an electromagnetic signal in the earth formation. Electric currents diffuse outwards from the transmitter into the surrounding formation. At different times, information arrives at the measurement sensor from different investigation depths. Particularly, at a sufficiently late time, the transient electromagnetic field is sensitive mainly to remote formation zones and only slightly depends on the resistivity distribution in the vicinity of the transmitter. This transient field is especially important for logging.

The transmitter may be either a single-axis or multi-axis electromagnetic and/or electric transmitter. In one embodiment, the transient electromagnetic (TEM) transmitters and TEM receivers are separate modules that are spaced apart and interconnected by lengths of cable, with the TEM transmitter and TEM receiver modules being separated by an interval of from one meter up to 200 meters, as selected. Radial depth of investigation δ is related to time by the relation δ=\sqrt{2t/σμ}. Thus, the depth of investigation increases with time t. Similarly, the conductivity σ of the surrounding material inversely affects the depth of investigation δ. As conductivity σ increases, the radial depth of investigation decreases. Finite conductivity casing of the apparatus, therefore, can reduce the radial depth of investigation.

Rapidly emerging measurement-while-drilling (MWD) technology introduces a new, deep (3-10 meters) scale for an electromagnetic logging application related to well navigation in thick reservoirs. The major problem associated with the MWD environment is the introduction of a metal drill pipe close to the area being measured. This pipe produces a very strong response and significantly reduces the sensitivity of the measured EM field to the effects of formation resistivities and remote boundaries. Previous solutions for this problem typically comprise creating a large spacing (up to 20 meters) between transmitter and receiver. However, the sensitivity of such a tool to remote boundaries is low.

In a typical transient induction tool, current in the transmitter coil drops from an initial value I₀ to 0 at the moment t=0. Subsequent measurements are taken while the rotating tool is moving along the borehole trajectory. The currents induced in the drilling pipe and in the formation (i.e., eddy currents) begin diffusing from the region close to the transmitter coil in all directions surrounding the transmitter. These currents induce electromagnetic field components that can be measured by induction coils placed along the conductive pipe. Signal contributions due to the eddy currents in the pipe are considered to be parasitic since the signal due to these eddy currents is much stronger than the signal from the formation. In order to receive a signal that is substantially unaffected by the eddy currents in the pipe, one can measure the signal at the very late stage, at a time when the signals from the formation dominate parasitic signals due to the pipe. Although the formation signal dominates at the late stage, it is also very small, and reliable measurement can be difficult. In prior methods, increasing the distance between transmitter and receivers reduces the influence of the pipe and shifts the dominant contribution of the formation to the earlier time range. Besides having limited resolution with respect to an oil/water boundary, such a system is very long (up to 10-15 m) which is not desirable and/or convenient for an MWD tool.

U.S. Pat. No. 7,150,316 to Itskovich, having the same assignee as the present invention and the contents of which are incorporated herein by reference, teaches an apparatus for use in a borehole in an earth formation and a method of using the apparatus. A tubular portion of the apparatus includes a damping portion for interrupting a flow of eddy currents. A transmitter positioned within the damping portion propagates a first transient electromagnetic signal in the earth formation. A receiver positioned within the damping portion axially separated from the transmitter receives a second transient electromagnetic signal indicative of resistivity properties of the earth formation. A processor determines from the first and second transient electromagnetic signals a resistivity of the earth formation. The damping portion includes at least one cut that may be longitudinal or azimuthal. A non-conductive material may be disposed within the cut. Alternatively, the damping portion may include segments having cuts and segments having a non-conducting material on an outer surface thereof.

It has been found that the device of Itskovich provides the ability to determine a distance to an interface in the earth formation in which the borehole is inclined at angles of less than 45° to the interface. The term “interface” is intended to include a boundary between two fluids in an earth formation and also a boundary between different layers of the earth formation. At larger inclinations, the resistivity sensor may be considered to be “looking ahead of the drill” and the ability to identify interfaces 10 m ahead of the bottomhole assembly is relatively poor. These larger angles are commonly encountered when first drilling into a reservoir. There is a need to reduce the parasitic signals caused by eddy currents in transient electromagnetic field signal detection methods without increasing a distance between transmitter and receiver. The present invention fulfills that need.

### SUMMARY OF THE INVENTION

One embodiment of the present invention is an apparatus for evaluating an earth formation. The apparatus includes a downhole assembly conveyed in a borehole in the earth formation. The downhole assembly may include a member having a finite, non-zero conductivity. A transmitter associated with the downhole assembly produces a first transient electromagnetic signal in the earth formation. A receiver receives a second transient electromagnetic signal resulting from interaction of the first transient electromagnetic signal with the earth formation, the receiver being spaced apart from the transmitter. An electromagnetic shield associated with the downhole assembly reduces an effect on the second transient electromagnetic signal of substantially direct coupling between the transmitter and the receiver. A magnetostatic shield associated with the downhole assembly reduces an effect on the second transient electromagnetic signal of currents induced in the downhole assembly by the first transient electromagnetic signal. The downhole assembly may include a bottomhole assembly conveyed on a drilling tubular. The magnetostatic shield may include a ferrite coating and/or a cut on the drilling tubular. The electromagnetic shield may comprise a highly conductive material. The apparatus may further include a processor configured to estimate from the second transient signal a distance to an interface in the earth formation and record the estimated distance on a suitable storage medium. A processor may further be configured to use reference signal in the estimation of the distance. The processor may be further configured control a direction of drilling of a bottomhole assembly. The transmitter may include a coil that is oriented with its axis that is substantially parallel to a longitudinal axis of the downhole assembly and/or substantially orthogonal to a longitudinal axis of the downhole assembly. The receiver may include a coil that is oriented with its axis substantially parallel to a longitudinal axis of the downhole assembly and/or substantially orthogonal to a longitudinal axis of a downhole assembly. The downhole assembly may include a member having a finite, non-zero conductivity.

Another embodiment of the invention is a method of evaluating an earth formation. The method includes conveying a downhole assembly into a borehole in the earth formation. A first transient electromagnetic signal is produced in the earth formation using a transmitter. A second transient electromagnetic signal resulting from interaction of the first transient electromagnetic signal with the earth formation is received by a receiver spaced apart from the transmitter. The receiver is electromagnetically shielded from substantially direct coupling with the transmitter. The receiver is also magnetostatically shielded from effects of currents induced in the downhole assembly by the first transient electromagnetic signal. The method may further include conveying a downhole assembly using a wireline and/or a drilling tubular. Magnetostatically shielding the receiver may further include providing a ferrite coating and/or a cut on a drilling tubular. Electromagnetically shielding the receiver may further include using a highly conductive material. The method may further include obtaining a reference signal with the downhole assembly suspended in air, and using the reference signal in estimating the distance. The estimated distance may be further use to control a direction of drilling of a bottomhole assembly. The estimated distance may be used in further operations.

Another embodiment of the invention is a computer-readable medium for use with an apparatus for evaluating an earth formation. The apparatus includes a transmitter and a receiver associated with a bottomhole assembly configured to be conveyed into a borehole in the earth formation. The transmitter is configured to generate a first transient electromagnetic signal in the earth formation. The receiver is configured to receive a second transient electromagnetic signal resulting from interaction of the first transient electromagnetic signal with the earth formation. The apparatus also includes an electromagnetic shield and a magnetostatic shield. The medium includes instructions that enable a processor to estimate a distance to an interface in the earth formation using the second transient electromagnetic signal. The medium may include a ROM, an EPROM, an EAROMs, a flash memory, and/or an optical disk.

### BRIEF DESCRIPTION OF THE DRAWINGS

The present invention is best understood with reference to the attached drawings in which like numerals refer to like elements, and in which:

FIG. 1 shows a measurement-while-drilling (MWD) tool suitable for use with the present invention;

FIG. 2 shows a schematic of an illustrative embodiment of the MWD tool of FIG. 1 and its trajectory in a horizontal well;

FIG. 3 shows a schematic vertical-section of an illustrative embodiment of the MWD tool of the present invention with a bed boundary ahead of the drillbit;

FIG. 4 shows an inability of a tool without shielding, but otherwise similar to the MWD tool of FIG. 3, to resolve the distance to a bed boundary in the absence of shielding;

FIG. 5 shows an insufficient ability of a tool with only electromagnetic shielding, but otherwise similar to the MWD tool of FIG. 3, to resolve the distance to a bed boundary with electromagnetic shielding only;

FIG. 6 shows an improved ability of a tool with only magnetostatic shielding, but otherwise similar to the MWD tool of FIG. 3, to resolve the distance to a bed boundary with magnetostatic shielding only;

FIG. 7 shows an ability of the MWD tool of FIG. 3 to resolve the distance to a bed boundary using electromagnetic shielding and magnetostatic shielding;

FIG. 8 shows an ability of the MWD tool of FIG. 3 to resolve the distance to a bed boundary using electromagnetic shielding and magnetostatic shielding and a calibration signal; and

FIG. 9 is a flow chart illustrating some of the steps of various illustrative embodiments of a method according to the present invention.

### DESCRIPTION OF PREFERRED EMBODIMENTS

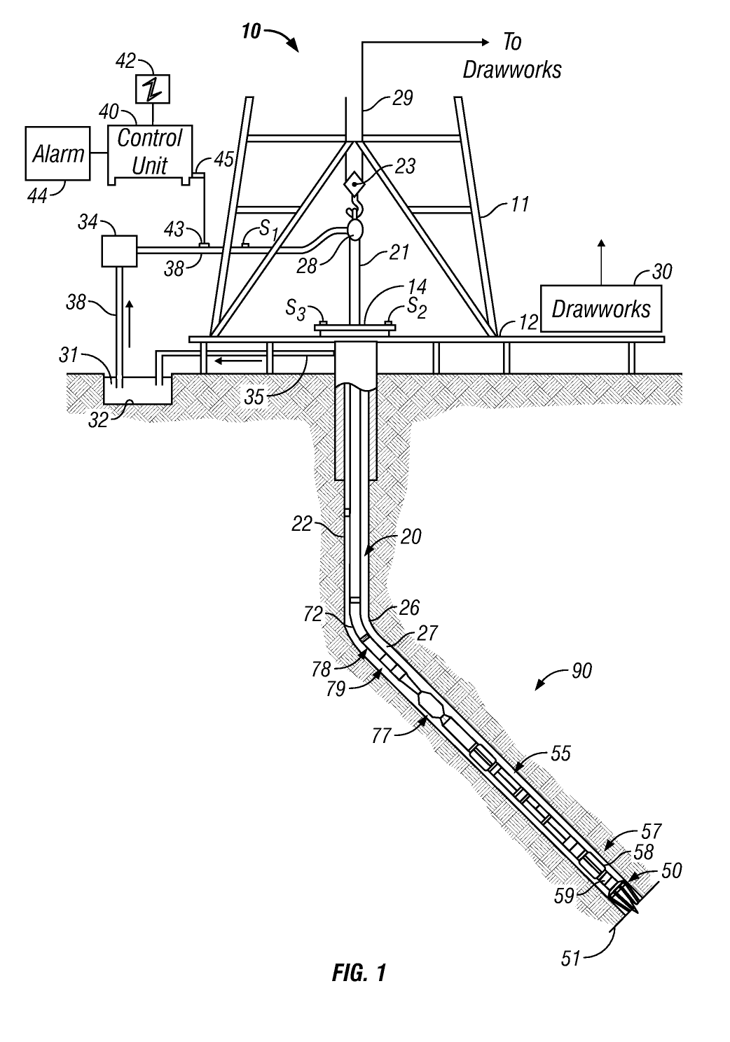

FIG. 1 shows a schematic diagram of a drilling system 10 with a drillstring 20 carrying a drilling assembly 90 (also referred to as the bottomhole assembly, or “BHA”) conveyed in a “wellbore” or “borehole” 26 for drilling the wellbore. The drilling system 10 includes a conventional derrick 11 erected on a floor 12 which supports a rotary table 14 that is rotated by a prime mover such as an electric motor (not shown) at a desired rotational speed. The drillstring 20 includes a tubing such as a drill pipe 22 or a coiled-tubing extending downward from the surface into the borehole 26. The drillstring 20 is pushed into the wellbore 26 when a drill pipe 22 is used as the tubing. For coiled-tubing applications, a tubing injector, such as an injector (not shown), however, is used to move the tubing from a source thereof, such as a reel (not shown), to the wellbore 26. The drill bit 50 attached to the end of the drillstring breaks up the geological formations when it is rotated to drill the borehole 26. If a drill pipe 22 is used, the drillstring 20 is coupled to a drawworks 30 via a Kelly joint 21, swivel 28, and line 29 through a pulley 23. During drilling operations, the drawworks 30 is operated to control the weight on bit, which is an important parameter that affects the rate of penetration. The operation of the drawworks is well known in the art and is thus not described in detail herein.

During drilling operations, a suitable drilling fluid 31 from a mud pit (source) 32 is circulated under pressure through a channel in the drillstring 20 by a mud pump 34. The drilling fluid passes from the mud pump 34 into the drillstring 20 via a desurger (not shown), fluid line 28 and Kelly joint 21. The drilling fluid 31 is discharged at the borehole bottom 51 through an opening in the drill bit 50. The drilling fluid 31 circulates uphole through the annular space 27 between the drillstring 20 and the borehole 26 and returns to the mud pit 32 via a return line 35. The drilling fluid acts to lubricate the drill bit 50 and to carry borehole cutting or chips away from the drill bit 50. A sensor S₁ preferably placed in the line 38 provides information about the fluid flow rate. A surface torque sensor S₂ and a sensor S₃ associated with the drillstring 20 respectively provide information about the torque and rotational speed of the drillstring. Additionally, a sensor (not shown) associated with line 29 is used to provide the hook load of the drillstring 20.

In one embodiment of the present invention, the drill bit 50 is rotated by only rotating the drill pipe 22. In another embodiment of the invention, a downhole motor 55 (mud motor) is disposed in the drilling assembly 90 to rotate the drill bit 50 and the drill pipe 22 is rotated usually to supplement the rotational power, if required, and to effect changes in the drilling direction.

In one embodiment of FIG. 1, the mud motor 55 is coupled to the drill bit 50 via a drive shaft (not shown) disposed in a bearing assembly 57. The mud motor rotates the drill bit 50 when the drilling fluid 31 passes through the mud motor 55 under pressure. The bearing assembly 57 supports the radial and axial forces of the drill bit. A stabilizer 58 coupled to the bearing assembly 57 acts as a centralizer for the lowermost portion of the mud motor assembly.

In one embodiment of the invention, a drilling sensor module 59 is placed near the drill bit 50. The drilling sensor module contains sensors, circuitry and processing software and algorithms relating to the dynamic drilling parameters. Such parameters preferably include bit bounce, stick-slip of the drilling assembly, backward rotation, torque, shocks, borehole and annulus pressure, acceleration measurements and other measurements of the drill bit condition. A suitable telemetry or communication sub 72 using, for example, two-way telemetry, is also provided as illustrated in the drilling assembly 90. The drilling sensor module processes the sensor information and transmits it to the surface control unit 40 via the telemetry system 72.

The communication sub 72, a power unit 78 and an MWD tool 79 are all connected in tandem with the drillstring 20. Flex subs, for example, are used in connecting the MWD tool 79 in the drilling assembly 90. Such subs and tools form the bottom hole drilling assembly 90 between the drillstring 20 and the drill bit 50. The drilling assembly 90 makes various measurements including the pulsed nuclear magnetic resonance measurements while the borehole 26 is being drilled. The communication sub 72 obtains the signals and measurements and transfers the signals, using two-way telemetry, for example, to be processed on the surface. Alternatively, the signals can be processed using a downhole processor in the drilling assembly 90.

The surface control unit or processor 40 also receives signals from other downhole sensors and devices and signals from sensors S₁-S₃ and other sensors used in the system 10 and processes such signals according to programmed instructions provided to the surface control unit 40. The surface control unit 40 displays desired drilling parameters and other information on a display/monitor 42 utilized by an operator to control the drilling operations. The surface control unit 40 preferably includes a computer or a microprocessor-based processing system, memory for storing programs or models and data, a recorder for recording data, and other peripherals. The control unit 40 is preferably adapted to activate alarms 44 when certain unsafe or undesirable operating conditions occur. Not shown in FIG. 1 are details about the logging tool of the present invention, discussed below.

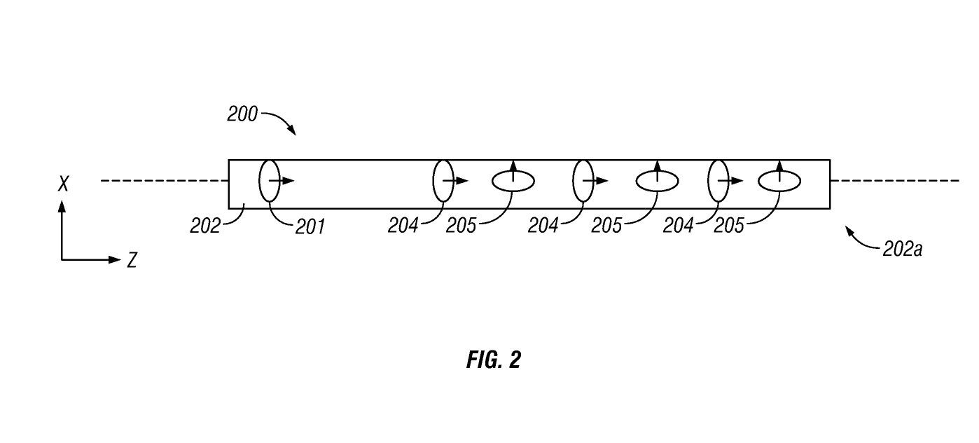

FIG. 2 shows an exemplary logging tool 200 suitable for use in a BHA in various illustrative embodiments of the present invention. A transmitter coil 201 and a receiver coil assembly 204, 205 are associated with a damping portion 202 of a drill pipe 202a by being positioned along the damping portion 202 of the drill pipe 202a for suppressing eddy currents. The longitudinal axis of the logging tool 200 defines a Z-direction of a coordinate system. An X-direction is defined so as to be perpendicular to the longitudinal axis of the logging tool 200. The damping portion 202 of the drill pipe 202a is of a length sufficient to interrupt a flow of eddy currents. Transmitter coil 201 is capable of inducing a magnetic moment. In the illustration of FIG. 2, for instance, the transmitter coil 201 is oriented to induce a magnetic moment along the Z-direction. The receiver coil assembly 204, 205 comprises an array of the Z-oriented coils 204 and the X-oriented coils 205 having magnetic moments oriented so as to be capable of detecting induced magnetic moments along orthogonal directions (i.e., M_{z}, and Mₓ, respectively). With a conductive drill pipe 202a without a damping portion 202, eddy currents produced in transient electromagnetic field measurements can make circumferential circuits coinciding with the drill pipe 202a surface. The eddy currents produced from a Z-transmitter, such as the Z-oriented transmitter coil 201 in FIG. 2, can exist for a long time and typically have the longest possible rate of decay of all transient electromagnetic signals. Longitudinal cuts disposed in the damping portion 202 force the eddy currents to follow one or more high resistivity paths instead of circumferential circuits, thereby inducing a quicker rate of decay of the eddy currents. Inducing a fast decay of the eddy currents in the drill pipe 202a enables improved measurements of the transient electromagnetic signal components. Such improvements enable improved determination of information, for instance, about positions of oil/water boundaries and/or resistivity of the surrounding earth formation.

Although FIG. 2 illustrates one configuration of the transmitter 201 and receiver(s) 204, 205, a variety of transmitter-receiver configurations can be used in various illustrative embodiments of the present invention. In a first embodiment of the MWD transient tool 200, the Z-oriented transmitter coil 201 can be positioned along the damping portion 202, and a receiver coil pair 205-204 comprising an X-oriented coil 205 and a Z-oriented receiver coil 204 may be axially displaced from the Z-oriented transmitter coil 201. The receiver pair 205-204 may typically be placed at a distance of from about 0 m to about 10 m from the transmitter coil 201, also along the damping portion 202. A transmitter-receiver distance less than approximately 2 m from the transmitter coil 201 may further enable geosteering. The term geosteering refers to control of the drilling direction of the BHA based upon determined distances from an interface in the earth formation. Typically, in geosteering, it is desirable to maintain the drilling of the borehole at a desired depth below a fluid interface such as an oil/water, gas/oil, or gas/water interface. Alternatively, geosteering may be used to maintain the wellbore within a reservoir rock at a desired distance from the caprock.

As noted above, Itskovich discloses the use of damping for interrupting the flow of eddy currents induced in a member of the BHA, such as a tubular like the drill pipe 202a. The damping portion 202 of the drill pipe 202a of the present illustrative embodiment has longitudinal cuts of sufficient length to interrupt the flow of eddy currents, in this case, about 10 m in length. The transmitter-receiver pair 201-205-204 may be placed centrally in the damping portion 202 of the drill pipe 202a. As an alternative to cuts, such as longitudinal cuts, disposed in the member of the BHA, such as the tubular like the drill pipe 202a, a ferrite coating may be provided on the member of the BHA, such as the tubular like the drill pipe 202a. The use of cuts or a non-conducting ferrite coating may be referred to as magnetostatic shielding. Itskovich also teaches the use of a ferrite coating to provide magnetostatic shielding.

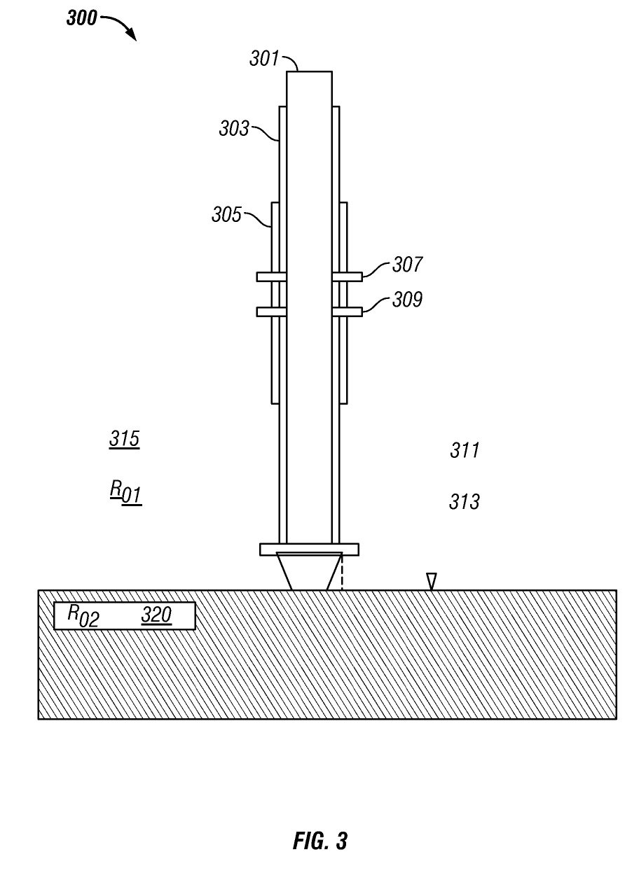

In addition to magnetostatic shielding, various illustrative embodiments of the present invention may also include electromagnetic shielding. This is schematically illustrated in FIG. 3. Shown therein is an MWD tool 300 having a drill collar 301. The transmitter is indicated by 307 while the receiver is indicated by 309. The drill collar 301 may be provided with a magnetostatic shield 305. In addition to the magnetostatic shield 305, the drill collar 301 may also be provided with an electromagnetic shield 303. The electromagnetic shield 303 may be made of a highly conductive material such as copper. The potential use of an electromagnetic shield 303 was recognized by the present inventors upon reviewing the differences between wireline and MWD resistivity measurement techniques. As noted in U.S. Pat. No. 6,906,521 to Tabarovsky et al., having the same assignee as the present invention, the contents of which are incorporated herein by reference, an MWD apparatus that includes a perfectly conducting mandrel acts in much the same way as a perfectly non-conducting logging tool body used in wireline applications. Methods developed over the years for wireline applications could then be used with little modification to MWD applications. One point of novelty in Tabarovsky may lie in the recognition of a problem caused by an imperfectly conducting mandrel and the development of a processing method to deal with the effects of an imperfectly conducting mandrel. The addition of a copper sheet as an electromagnetic shield 303 may, in various illustrative embodiments of the present invention, be viewed as a hardware solution to the problem of an imperfectly conducting mandrel. An imperfectly conducting mandrel may be regarded as having a finite, non-zero conductivity.

Modeling results may be used to illustrate the effectiveness of the approach described in various illustrative embodiments of the present invention. A two-layered formation as shown in FIG. 3 may be used. The MWD tool 300 may be placed in a resistive upper half-space 315 with a resistivity R₀₁ of 50 Ω-m. Ahead of a drillbit 311, on the other side of a boundary 313 is a medium 320 with a resistivity R₀₂ of 1 Ω-m. The boundary may be at a distance (0-5 m) below the drillbit 311. The boundary 313 may be a bed boundary or may, for example, be a fluid interface between a hydrocarbon-saturated formation and a water-saturated formation. The parameters of the model used in the modeling are the following:

### The pipe radius=6 cm;

### Pipe thickness=1 cm;

### Resistivity of the pipe=0.714×10⁻⁶ Ω-m;

### Copper cover thickness=0.5 cm;

### Copper cover length=8 m;

### Resistivity of the copper shield=1.7×10⁻⁰⁸ Ω-m;

### Ferrite length=3 m;

### Ferrite thickness=1 cm;

### Ferrite relative permeability=2000;

### Resistivity R₀₁ of the resistive half-space 315 R₀₁=50 Ω-m; and

### Resistivity R₀₂ of the conductive half-space 320 R₀₂=1 Ω-m.

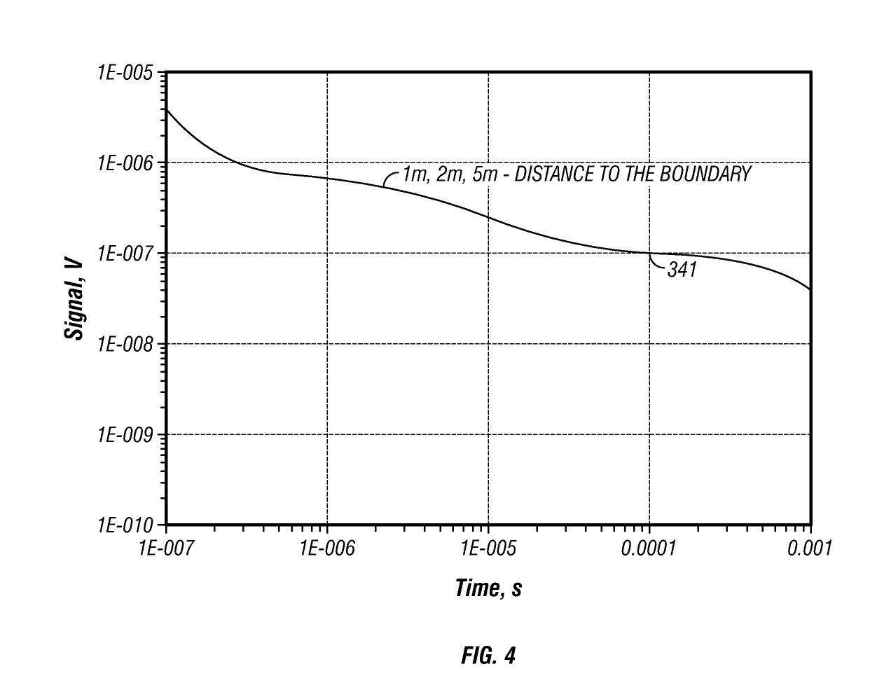

FIG. 4 shows an inability of a tool without shielding, but otherwise similar to the MWD tool 300 of FIG. 3, to resolve the distance to the boundary 313 in the absence of shielding. FIG. 4 shows transient electromagnetic signals 341, measured in volts (V) plotted against time (sec), corresponding to different distances of the interface 313 (1 m, 2 m, and 5 m) from the drillbit 311 with no electromagnetic shielding 303 and no magnetostatic shielding 305. As can be seen from FIG. 4, the transient electromagnetic signals 341 corresponding to the different distances of the interface 313 (1 m, 2 m, and 5 m) from the drillbit 311 are not distinguishable in a case of a tool with no electromagnetic shielding 303 and no magnetostatic shielding 305. This makes it difficult to estimate the distance to the interface 313 ahead of the drillbit 311, an important part of evaluation of an earth formation. The term “evaluate” is to be given its dictionary meaning, i.e., “to examine and judge concerning the worth, quality, significance, amount, degree, or condition.” The transient electromagnetic signals 341 at the receiver 309 result from excitation of the transmitter 307, which produces a transient electromagnetic signal in the earth formation that interacts with the earth formation, resulting in the transient electromagnetic signals 341 received at the receiver 309.

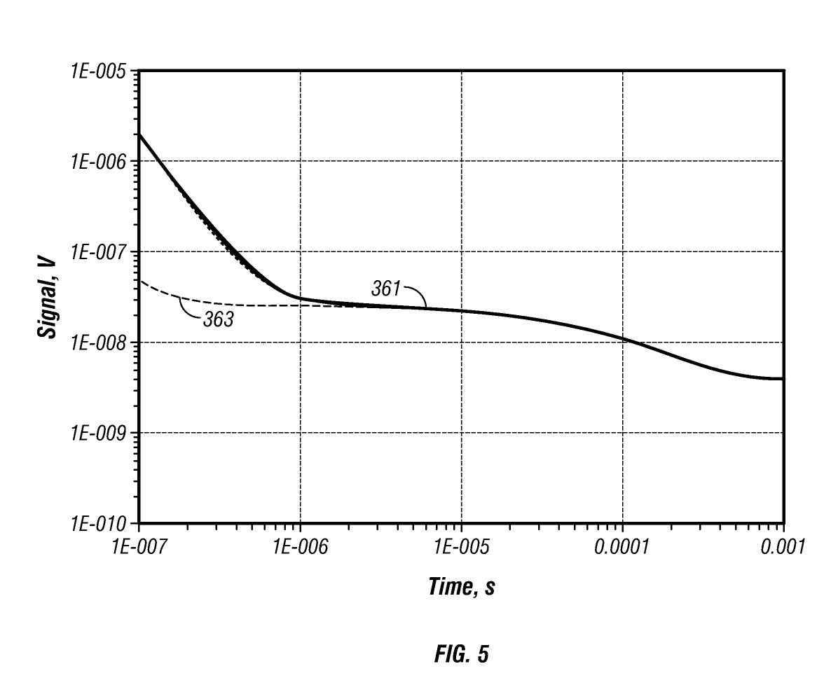

FIG. 5 shows an insufficient ability of a tool with only electromagnetic shielding 303, but otherwise similar to the MWD tool 300 of FIG. 3, to resolve the distance to the boundary 313 with electromagnetic shielding 303 only. FIG. 5 shows modeling results illustrating an effect due to the electromagnetic shielding 303. FIG. 5 shows transient electromagnetic signals 361, measured in volts (V) plotted against time (sec), corresponding to the different distances of the interface 313 (1 m, 2 m, and 5 m) from the drillbit 311 with the electromagnetic shielding 303, but with no magnetostatic shielding 305. As can be seen from FIG. 5, the transient electromagnetic signals 361 corresponding to the different distances of the interface 313 (1 m, 2 m, and 5 m) from the drillbit 311 are again not distinguishable in the case of a tool with the electromagnetic shielding 303, but with no magnetostatic shielding 305. Again, as in FIG. 4, the transient electromagnetic signals 361 for the difference distances are indistinguishable from each other. Also shown is a reference calibration signal 363 obtained when the tool with the electromagnetic shielding 303, but with no magnetostatic shielding 305, is suspended in air. Comparison of FIG. 5 with FIG. 4 shows the electromagnetic shielding 303 made of copper by itself does not improve the resolution, but it does reduce the transient electromagnetic signal intensity from both the earth formation and the metal pipe.

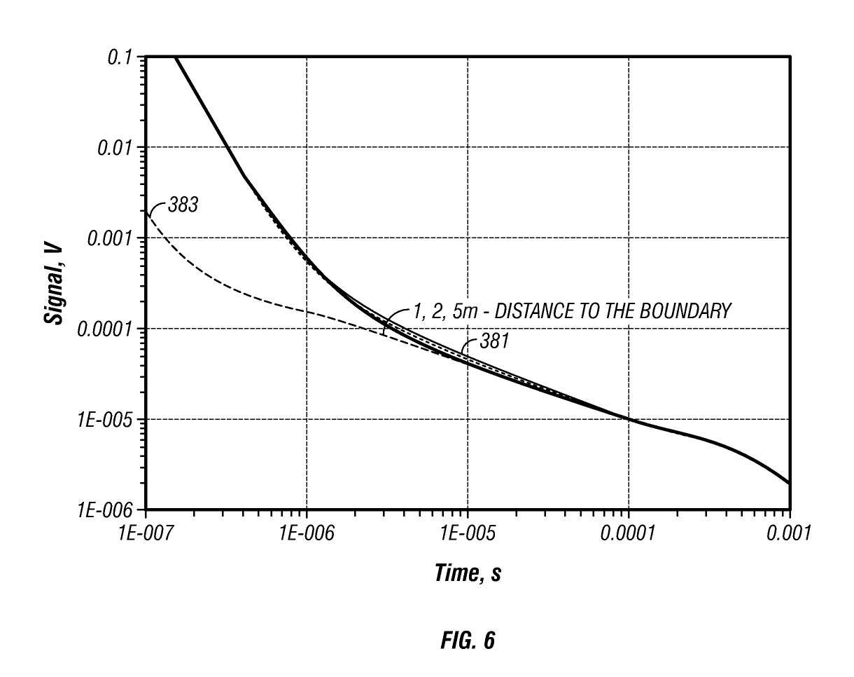

Turning now to FIG. 6, simulation results with only the magnetostatic shielding 305 are shown. FIG. 5 shows an improved ability of a tool with only magnetostatic shielding 305, but otherwise similar to the MWD tool 300 of FIG. 3, to resolve the distance to the boundary 313 with magnetostatic shielding 305 only. FIG. 6 shows transient electromagnetic signals 381, measured in volts (V) plotted against time (sec), corresponding to the different distances of the interface 313 (1 m, 2 m, and 5 m) from the drillbit 311 with the magnetostatic shielding 305, but with no electromagnetic shielding 303. As can be seen from FIG. 6, the transient electromagnetic signals 381 corresponding to the different distances of the interface 313 (1 m, 2 m, and 5 m) from the drillbit 311 are somewhat distinguishable in the case of a tool with the magnetostatic shielding 305, but with no electromagnetic shielding 303. Some separation between the transient electromagnetic signals 381 at different distances to the interface 313 is noted, but the ability to do estimates of distances to interfaces, such as the interface 313, ahead of the drillbit 311 would still be limited. A curve 383 gives a reference calibration signal with the logging tool with the magnetostatic shielding 305, but with no electromagnetic shielding 303, suspended in air.

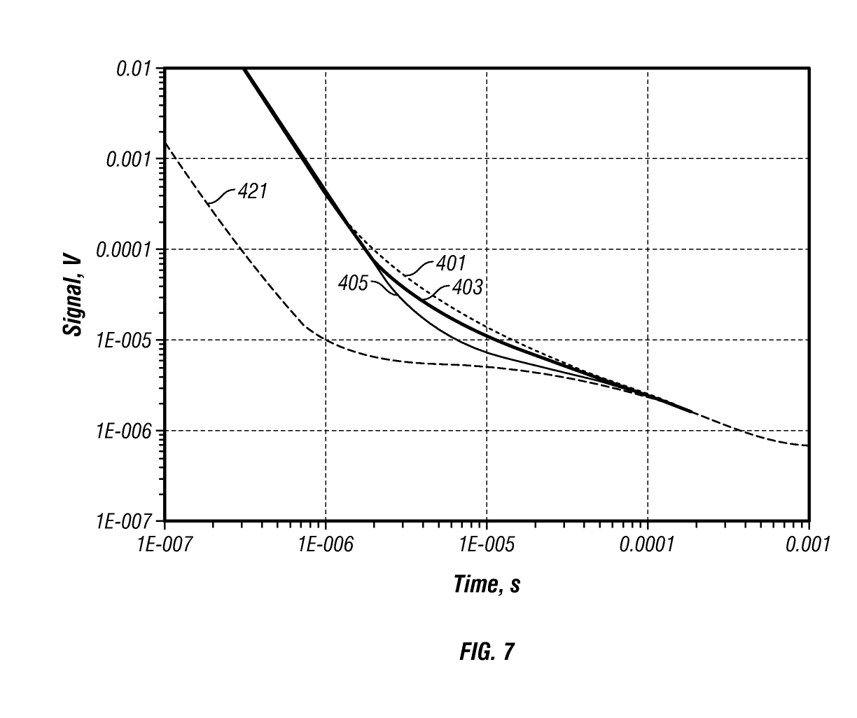

When both the electromagnetic shielding 303 and the magnetostatic shielding 305 are used, however, as in the case of the MWD tool 300 as shown in FIG. 3, for example, the separation of the curves becomes much greater. FIG. 7 shows an ability of the MWD tool 300 of FIG. 3 to resolve the distance to the boundary 313 using the electromagnetic shielding 303 and the magnetostatic shielding 305. This is shown in FIG. 7 where transient electromagnetic signals represented by curves 401, 403, and 405 correspond to distances of 1 m, 2 m, and 5 m, respectively, ahead of the drillbit 311. FIG. 7 shows the transient electromagnetic signals represented by the curves 401, 403, and 405, measured in volts (V) plotted against time (sec), corresponding to the different distances of the interface 313 (1 m, 2 m, and 5 m) from the drillbit 311 with both the electromagnetic shielding 303 and the magnetostatic shielding 305. As can be seen from FIG. 7, the transient electromagnetic signals represented by the curves 401, 403, and 405, corresponding to the different distances of the interface 313 (1 m, 2 m, and 5 m) from the drillbit 311, are clearly distinguishable in the case of the MWD tool 300 as shown in FIG. 3, for example, having both the electromagnetic shielding 303 and the magnetostatic shielding 305. The reference calibration signal is given by a curve 421.

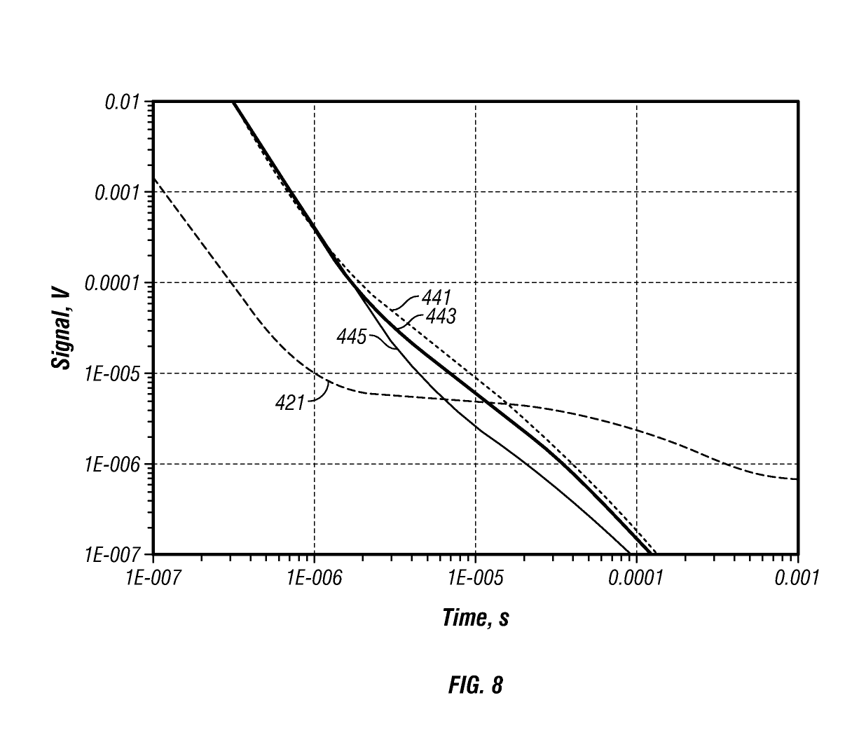

The use of the reference calibration signal, such as the reference calibration signal 421, for example, was discussed in Itskovich. As taught therein, the reference calibration signal 421 may be subtracted from the transient electromagnetic signals represented by the curves 401, 403, and 405 measured under downhole conditions. When this is done, curves 441, 443, and 445, corresponding to the different distances of the interface 313 (1 m, 2 m, and 5 m) from the drillbit 311, as shown in FIG. 8, are obtained. FIG. 8 shows an ability of the MWD tool of FIG. 3 to resolve the distance to the boundary 313 using both the electromagnetic shielding 303 and the magnetostatic shielding 305 and the reference calibration signal 421.

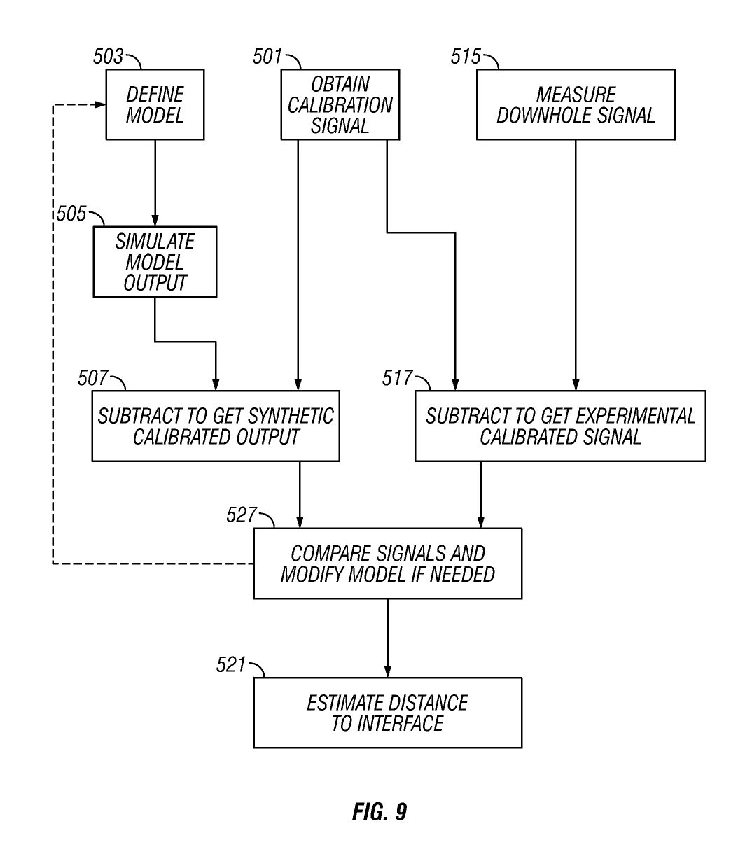

The MWD tool 300 of FIG. 3 may thus be used to determine distances to an interface such as the boundary 313 ahead of the drill bit 311. FIG. 9 is a flow chart illustrating some of the steps of various illustrative embodiments of a method according to the present invention. In various illustrative embodiments, the steps that may be used to determine distances to an interface such as the boundary 313 ahead of the drill bit 311 may be illustrated in FIG. 9. A calibration signal is obtained 501 with the MWD tool 300 suspended in air. Initially, a resistivity model of the earth formation ahead of the drillbit 311 is defined 503. The initial resistivity model may come from knowledge of the local geology or it may be based on data from previously drilled wells. A model output for the initial model is simulated 505 and a calibrated model output obtained 507 by subtraction. Downhole signals measured 515 by the downhole tool 300 are also calibrated 517 by subtraction. Comparison of the calibrated downhole signal 517 with calibrated model output 507 then enables correction 527 of the initial resistivity model to provide the best fit between measured and synthetic responses. The iterative process of synthetic model adjustment stops when desirable fit is reached. This inversion process permits determination of resistivity of formation as well as the distance to the interface 313, as indicated at 521, for example.

It should be noted that the simulations results shown above in FIGS. 4-8 were for signals at a Z-oriented receiver coil, such as the Z-oriented receiver coil 204, corresponding to a Z-oriented transmitter coil, such as the Z-oriented transmitter coil 201. The method of the present invention may also be used with other transmitter-receiver configurations and/or combinations and, in particular, with an X-oriented receiver coil, such as the X-oriented receiver coil 205, with a Z-oriented transmitter coil, such as the Z-oriented transmitter coil 201, for example.

Once the distance to the interface 313 has been determined, appropriate alteration of the drilling direction may be made. This could include altering the borehole direction to avoid intersecting the interface 313, or deviating the borehole to reach a specified distance from the interface 313. The alteration may be done automatically by a processor (possibly downhole) and/or by telemetry commands from the surface. The interface 313 may be an interface between two fluids (selected from oil, water and gas), or the interface 313 may be a bed boundary. The interface providing the resistivity contrast may be a boundary between two layers or it may be an interface between two fluids in a formation. The processed data resulting from the processing described above may be displayed and/or stored on a suitable medium. The results of the processing may be used for further operations in prospect evaluation and development. This specifically includes using the determined geometry of subsurface reservoirs to establish the volume of recoverable reserves, and the drilling of additional exploration, evaluation and development wells.

The method of the present disclosure has been in terms of a bottomhole assembly conveyed on a drilling tubular. The method may also be practiced using devices on a logging string conveyed on a wireline. Collectively, the bottom hole assembly and a wireline-conveyed logging string may be referred to as downhole assemblies.

The processing of the data may be accomplished by a downhole processor or a surface processor. Implicit in the control and processing of the data is the use of a computer program implemented on a suitable machine-readable medium that enables the processor to perform the control and processing. The machine-readable medium may include ROMs, EPROMs, EAROMs, flash memories and/or optical disks.

While the foregoing disclosure is directed to various preferred embodiments of the present invention, various modifications will be apparent to those skilled in the art having the benefit of the present disclosure. It is intended that all such variations within the scope and spirit of the appended claims be embraced by the present disclosure.

What is claimed is:

1. An apparatus for evaluating an earth formation, the apparatus comprising:
(a) a downhole assembly configured to be conveyed in a borehole in the earth formation;
(b) a transmitter on the downhole assembly configured to generate a first transient electromagnetic signal in the earth formation;
(c) a receiver configured to receive a second transient electromagnetic signal resulting from interaction of the first transient electromagnetic signal with the earth formation, the receiver spaced apart from the transmitter;
(d) an electromagnetic shield associated with the downhole assembly configured to reduce an effect on the second transient electromagnetic signal of substantially direct coupling between the transmitter and the receiver; and
(e) a magnetostatic shield associated with the downhole assembly configured to reduce an effect on the second transient electromagnetic signal of currents induced in the downhole assembly by the first transient electromagnetic signal.

2. The apparatus of claim 1 wherein the downhole assembly comprises a bottomhole assembly (BHA) conveyed on a drilling tubular.

3. The apparatus of claim 1 wherein the magnetostatic shield comprises at least one of; (i) a ferrite coating, and (ii) a cut on a drilling tubular.

4. The apparatus of claim 1 wherein the electromagnetic shield comprises a highly conductive material.

5. The apparatus of claim 1 further comprising a processor configured to:
(i) estimate from the second transient signal a distance to an interface in the earth formation, and
(ii) record the estimated distance on a suitable storage medium.

6. The apparatus of claim 5 wherein the processor is further configured to use a reference signal in the estimation of the distance.

7. The apparatus of claim 5 wherein the processor is further configured to control a direction of drilling of a bottomhole assembly.

8. The method of claim 1 wherein the transmitter includes a coil that is oriented with its axis that is one of (i) substantially parallel to a longitudinal axis of the downhole assembly, and (ii) substantially orthogonal to a longitudinal axis of the downhole assembly.

9. The method of claim 1 wherein the receiver includes a coil that is oriented with its axis that is one of (i) substantially parallel to a longitudinal axis of the downhole assembly, and (ii) substantially orthogonal to a longitudinal axis of the downhole assembly.

10. The apparatus of claim 1 wherein the downhole assembly includes a member having a finite, non-zero conductivity;

11. A method of evaluating an earth formation, the method comprising:
(a) conveying a downhole assembly into a borehole in the earth formation;
(b) electromagnetically and magnetostatically shielding a receiver on the downhole assembly from a transmitter on the downhole assembly;
(c) producing a first transient electromagnetic signal in the earth formation using a transmitter associated with the downhole assembly;
(d) receiving a second transient electromagnetic signal resulting from interaction of the first transient electromagnetic signal with the earth formation using a receiver associated with the downhole assembly,
(e) estimating from the second transient signal a distance to an interface in the earth formation; and
(f) recording the estimated distance on a suitable storage medium.

12. The method of claim 11 wherein conveying the downhole assembly further comprises using at least one of; (i) a wireline, and (ii) a drilling tubular.

13. The method of claim 11 wherein magnetostatically shielding the receiver further comprises providing at least one of: (i) a ferrite coating, and (ii) a cut on a drilling tubular.

14. That method of claim 11 wherein electromagnetically shielding the receiver further comprises using a highly conductive material.

15. The method of claim 11 further comprising:
(i) obtaining a reference signal with the downhole assembly suspended in air, and
(ii) using the reference signal in estimating the distance.

16. The method of claim 11 further comprising using the estimated distance to control a direction of drilling of a bottomhole assembly.

17. The method of claim 11 further comprising using a coil on the transmitter that is oriented with its axis that is one of (i) substantially parallel to a longitudinal axis of the downhole assembly, and (ii) substantially orthogonal to a longitudinal axis of the downhole assembly.

18. The method of claim 11 further comprising using a coil on the receiver that is oriented with its axis that is one of (i) substantially parallel to a longitudinal axis of the downhole assembly, and (ii) substantially orthogonal to a longitudinal axis of the downhole assembly.

19. That method of claim 11 further comprising using the estimated distance in further operations.

20. A computer-readable medium for use with an apparatus for evaluating an earth formation, the apparatus comprising:
(a) a downhole assembly configured to be conveyed in a borehole in the earth formation, the downhole assembly including a member having a finite, non-zero conductivity;
(b) a receiver electromagnetically shielded and magnetostatically shielded from a transmitter on the downhole assembly, the transmitter configured to generate a first transient electromagnetic signal, the receiver configured to receive a second transient electromagnetic signal resulting from interaction of the first transient electromagnetic signal with the earth formation,
the medium comprising instructions which enable a processor to:
(c) estimate from the second transient signal a distance to an interface in the earth formation; and
(d) store the estimated distance on a suitable storage medium.

21. The medium of claim 20 further comprising at least one of: (i) a ROM, (ii) an EPROM, (iii) an EAROMs, (iv) a flash memory, and (v) an optical disk.
